(19) United States
(12) Patent Application Publication
(10) Pub. No.: US 2005/0109569 A1
(43) Pub. Date: May 26, 2005

(54) Piston for disc brake assembly

(76) Inventors: Robert S. Sporzynski, Chelsea, MI (US); Charles Giacomazza, Ypsilanti, MI (US); Christopher O. McCormick, Novi, MI (US); Sung K. Kim, Ann Arbor, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/930,689

(22) Filed: Aug. 31, 2004

Related U.S. Application Data
(60) Provisional application No. 60/524,835, filed on Nov. 25, 2003.

(51) Int. Cl. F16D 65/78

(52) U.S. Cl. 188/218 XL

(57) ABSTRACT

A piston adapted for use in a disc brake assembly includes a first end and an opposite second end. At least one of the first and second ends includes a center column and an outer shell. The center column protrudes outwardly beyond the outer shell.

### BACKGROUND OF THE INVENTION

This invention relates in general to vehicle disc brake assemblies and in particular to an improved structure for a piston adapted for use in such a vehicle disc brake assembly.

Most vehicles are equipped with a brake system for retarding or stopping movement of the vehicle in a controlled manner. A typical brake system for an automobile or light truck includes a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, as well as the actuators therefor, are well known in the art.

A typical disc brake assembly includes a rotor which is secured to the wheel of the vehicle for rotation therewith. A caliper assembly is slidably supported by pins secured to an anchor plate. The anchor plate is secured to a fixed, non-rotatable component of the vehicle, such as a steering knuckle (when the disc brake assembly is installed for use on the front of the vehicle), or an axle flange (when the disc brake assembly is installed for use on the rear of the vehicle).

The caliper assembly includes a pair of brake shoes which are disposed on opposite sides of the rotor. The brake shoes are operatively connected to one or more hydraulically actuated pistons for movement between a non-braking position, wherein they are spaced apart from opposed axial sides or braking surfaces of the rotor, and a braking position, wherein they are moved into frictional engagement with the opposed braking surfaces of the rotor. When the operator of the vehicle depresses the brake pedal, the piston urges the brake shoes from the non-braking position to the braking position so as to frictionally engage the opposed braking surfaces of the rotor and thereby slow or stop the rotation of the associated wheel of the vehicle.

A considerable amount of heat is generated between the rotor and the brake shoes during braking. In a disc brake assembly having a piston constructed from a metallic material, the heat generated during braking will not usually damage the surface of the open end of the piston but can cause brake fluid boil. Unfortunately, a disc brake piston which is formed from a metallic material is relatively expensive. It is less expensive to manufacture a disc brake piston from a plastic material than from a metallic material. U.S. Pat. No. 5,575,358 to McCormick, U.S. Pat. No. 5,713,435 to Schneider et al., U.S. Pat. No. 4,928,579 to Emmett, U.S. Pat. No. 4,449,447 to Yanagi, U.S. Pat. No. 4,401,012 to Emmett, and Japanese Patent No. 5718857 disclose prior art disc brake pistons. However, in a disc brake assembly having a piston formed from plastic material, it has been found that the heat generated during braking can cause damage to the surface of the piston but will not usually cause brake fluid boil. Thus, it would be desirable to provide an improved structure for a piston adapted for use in a vehicle disc brake assembly which is durable, yet relatively inexpensive to manufacture.

### SUMMARY OF THE INVENTION

This invention relates to a piston adapted for use in a disc brake assembly. The piston includes a first end and an opposite second end. At least one of the first and second ends includes a center column and an outer shell. The center column protrudes outwardly beyond the outer shell.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a sectional elevational view of a portion of a prior art vehicle disc brake assembly.

FIG. 2 is a sectional view of a first embodiment of a disc brake piston in accordance with this invention.

FIG. 3 is a sectional view of a second embodiment of a disc brake piston in accordance with this invention.

FIG. 4 is a sectional view of a third embodiment of a disc brake piston in accordance with this invention.

FIG. 5 is a sectional view of a fourth embodiment of a disc brake piston in accordance with this invention.

FIG. 6 is a sectional view of a fifth embodiment of a disc brake piston in accordance with this invention.

FIG. 7 is a sectional view of a sixth embodiment of a disc brake piston in accordance with this invention.

FIG. 7A is a sectional view of a portion of the sixth embodiment of the disc brake piston in accordance with this invention.

FIG. 7B is an enlarged sectional view of a portion of the sixth embodiment of the disc brake piston in accordance with this invention.

FIG. 8 is a sectional view of a seventh embodiment of a disc brake piston in accordance with this invention.

FIG. 9 is a sectional view of an eighth embodiment of a disc brake piston in accordance with this invention.

FIG. 10 is a view of a cap adapted for use with the disc brake piston illustrated in FIG. 9 in accordance with this invention.

FIG. 11 is an end view of the disc brake piston illustrated in FIG. 9.

FIG. 12 is an end view of the cap illustrated in FIG. 10.

FIG. 13 is an end view of a ninth embodiment of a disc brake piston in accordance with this invention.

FIG. 14 is a side view of a portion of the disc brake piston illustrated in FIG. 13.

FIG. 15 is an end view of a tenth embodiment of a disc brake piston in accordance with this invention.

FIG. 16 is a side view of a portion of the disc brake piston illustrated in FIG. 14.

FIG. 17 is an end view of an eleventh embodiment of a disc brake piston in accordance with this invention.

FIG. 18 is a side view of a portion of the disc brake piston illustrated in FIG. 17.

FIG. 19 is a sectional view of a twelfth embodiment of a disc brake piston in accordance with this invention.

FIG. 20 is a sectional view of a thirteenth embodiment of a disc brake piston in accordance with this invention.

FIG. 21 is a sectional view of a fourteenth embodiment of a disc brake piston in accordance with this invention.

FIG. 22 is a sectional view of a fifteenth embodiment of a disc brake piston in accordance with this invention.

### DESCRIPTION OF THE PREFERRED EMBODIMENTS

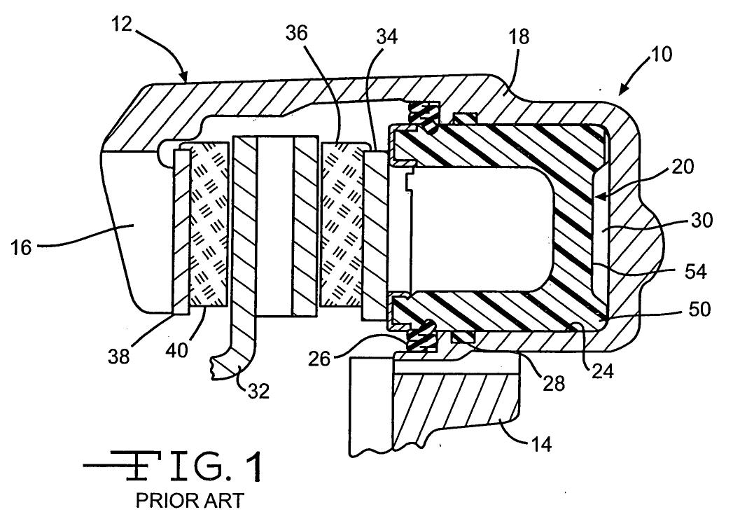

Referring now to the drawings, there is illustrated in FIG. 1 a portion of a prior art vehicle disc brake assembly, indicated generally at 10. The general structure and operation of the prior art disc brake assembly 10 is conventional in the art. Thus, only those portions of the prior art disc brake assembly 10 which are necessary for a full understanding of this invention will be explained and illustrated. Although this invention will be described and illustrated in conjunction with the particular vehicle disc brake assembly disclosed herein, it will be appreciated that this invention may be used in conjunction with other disc brake assemblies. The prior art disc brake assembly 10 is disclosed in U.S. Pat. No. 5,575,358 to McCormick, U.S. Pat. No. 5,713,435 to Schneider et al., copies of which are attached hereto and the disclosures of which are incorporated herein.

The prior art disc brake assembly 10 includes a generally C-shaped caliper, indicated generally at 12. The caliper 12 includes an inboard leg portion 14 and an outboard leg portion 16 which are interconnected by an intermediate bridge portion 18. The caliper 12 is slidably supported on pins (not shown) extending outwardly from an anchor plate (not shown) which, in turn, is secured to a stationary component of the vehicle. The pins permit the caliper 12 to slide in both the outboard direction (left when viewing FIG. 1) and the inboard direction (right when viewing FIG. 1). Such sliding movement of the caliper 12 occurs when the disc brake assembly 10 is actuated, as will be explained below.

An actuation means, indicated generally at 20, is provided for effecting the operation of the disc brake assembly 10. The actuation means 20 includes a piston, indicated generally at 50, which is disposed in a counterbore or recess 24 formed in the outboard surface of the inboard leg 14 of the caliper 12. The actuation means 20, shown in this embodiment as being a hydraulic actuation means, is operable to reciprocally move the piston 50 within the recess 24. However, other types of actuation means 20, such as for example, electrical and mechanical types, can be used.

The disc brake assembly 10 also includes a dust boot seal 26 and an annular fluid seal 28. The dust boot seal 26 is formed from a flexible material and has a first end which engages an outboard end of the recess 24. A second end of the dust boot seal 26 engages an annular groove formed in an outer side wall of the piston 50. A plurality of flexible convolutions are provided in the dust boot seal 26 between the first and second ends thereof. The dust boot seal 26 is provided to prevent water, dirt, and other contaminants from entering into the recess 24. The fluid seal 28 is disposed in an annular groove formed in a side wall of the recess 24 and engages the outer side wall of the piston 50. The fluid seal 28 is provided to define a sealed hydraulic actuator chamber 30, within which the piston 50 is disposed for sliding movement.

The disc brake assembly 10 further includes a rotor 32, which is connected to a wheel (not shown) of the vehicle for rotation therewith. The rotor 32 extends radially outwardly between an inboard backing plate 34, which supports an inboard friction pad 36, and an outboard backing plate 38, which supports an outboard friction pad 40. The inboard and outboard backing plates 34 and 38, respectively, can be supported on guide rails (not shown) provided on the anchor plate. Alternatively, the inboard backing plate 34 can be supported on the piston 50, while the outboard backing plate 38 can be supported on the outboard leg portion 16 of the caliper 12.

When it is desired to brake the rotation of the brake rotor 32 and the vehicle wheel associated therewith, pressurized hydraulic fluid is introduced into the chamber 30. Such pressurized hydraulic fluid urges the piston 50 in the outboard direction (toward the left when viewing FIG. 1). As a result, the inboard friction pad 36 is moved into engagement with an inboard braking surface of the rotor 32. At the same time, the caliper 12 slides in the inboard direction (toward the right when viewing FIG. 1) such that the outboard friction pad 40 is moved into engagement with an outboard braking surface of the brake rotor 32. As a result, the friction pads 36 and 40 frictionally engage the opposed axial sides of the rotor 32 to retard relative rotational movement thereof. The structure and operation of the disc brake assembly 10 thus far described is conventional in the art.

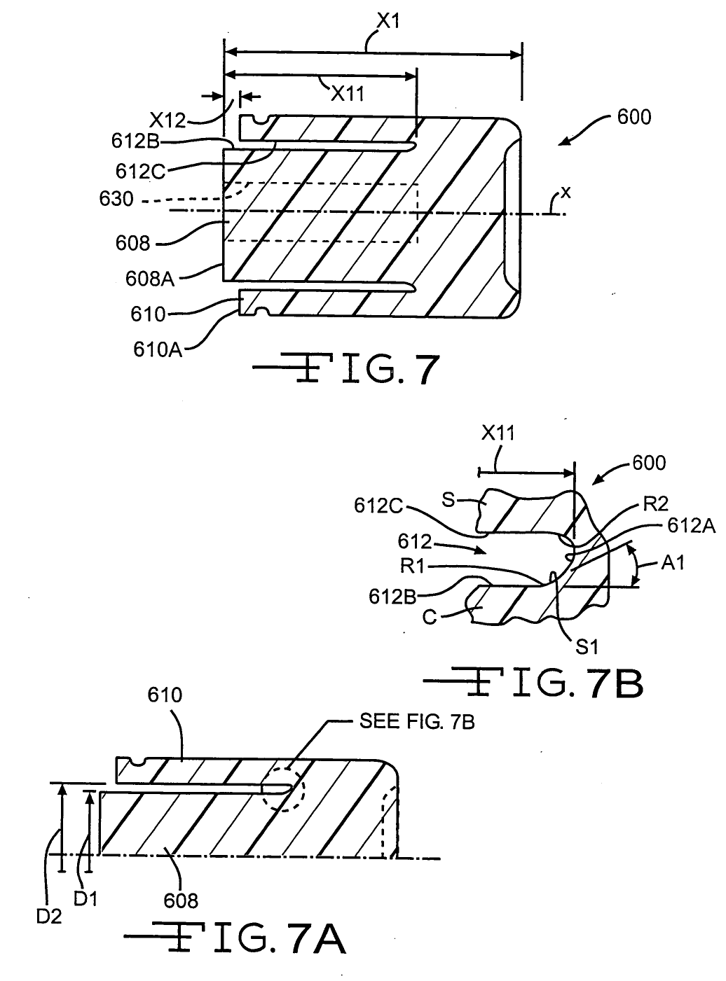

The specific construction of the prior art disc brake piston 50 illustrated in FIG. 1 is disclosed in U.S. Pat. No. 5,575,358 to McCormick and U.S. Pat. No. 5,713,435 to Schneider et al., the disclosures of these patents herein incorporated by reference. Alternatively, the prior art disc brake piston 50 can have one of the other constructions as disclosed in U.S. Pat. No. 5,713,435 to Schneider et al., such as the construction shown in FIGS. 7-9.

Turning now to FIG. 2, there is illustrated a first embodiment of a disc brake piston, indicated generally at 100, in accordance with this invention. As shown therein, the piston 100 includes a body 102 which is preferably molded from a synthetic resin material. However, the piston 100 can be formed from other materials, such as for example, ceramic, titanium and other metal alloys. The body 102 of the piston 100 is generally hollow and cylindrical in shape, having a closed end 104 and an opposite opened end 106. The opened end 106 has a stepped configuration and includes a first or outermost end 106A, a second end 106B which is spaced inwardly relative to the first end 106A toward the closed end 104, and a third surface or shoulder 106C.

The piston 100 includes an axially extending inner cylindrical surface 110 and an axially extending outer cylindrical surface 112 formed on the body 102. The inner cylindrical surface 110 and the outer cylindrical surface 112 are preferably concentric with a longitudinal axis X of the piston 100. The inner cylindrical surface 110 includes a bottom or end wall 110A. In this embodiment, the piston 100 includes an annular groove 116 formed in the outer cylindrical surface 112 of the body 102 adjacent to the opened end 106 thereof. The groove 116 is adapted to receive the second end of the dust boot seal 26 therein, as described above in connection with prior art disc brake assembly 10.

In this embodiment, the piston 100 defines a first axial dimension X1 from the closed end 104 to the opened end 106; a second axial dimension X2 from the bottom wall 110A to the opened end 106; and a third axial dimension X3 from the second end 106B to the opened end 106. In the illustrated embodiment, the dimension X2 is greater than one-half the dimension X1; however, the dimension X2 can be generally equal to one-half the dimension X1 or can be less than one-half the dimension X1 if so desired. Preferably, the dimension X3 is typically in the range from about 0.001 times X1 to about 0.1 times X1; however, the dimension X3 can be other than within this range if so desired.

In this embodiment, the piston 100 defines a first diameter Y1 defined by the outer cylindrical surface 112; a second diameter Y2 defined by the shoulder 106C; and a radial dimension Y3 from the shoulder 106C to the outer cylindrical surface 112. In the embodiment, the diameter Y2 is greater than one-half the diameter Y1; however, the diameter Y2 can be generally equal to one-half the diameter Y1 or can be less than one-half the diameter Y1 if so desired. Preferably, the dimension Y3 is approximately in the range of 0.1 times Y1 to about 0.4 times Y1; however, the dimension Y3 can be other than within this range if so desired. That portion of the piston 100 defined by the dimensions Y2 and X1 defines a piston center column C, and that portion of the piston 100 defined by the dimensions Y3 and (X1-X3) defines a piston outer shell S. Alternatively, the structure of the disc brake piston 100 can be other than illustrated if so desired.

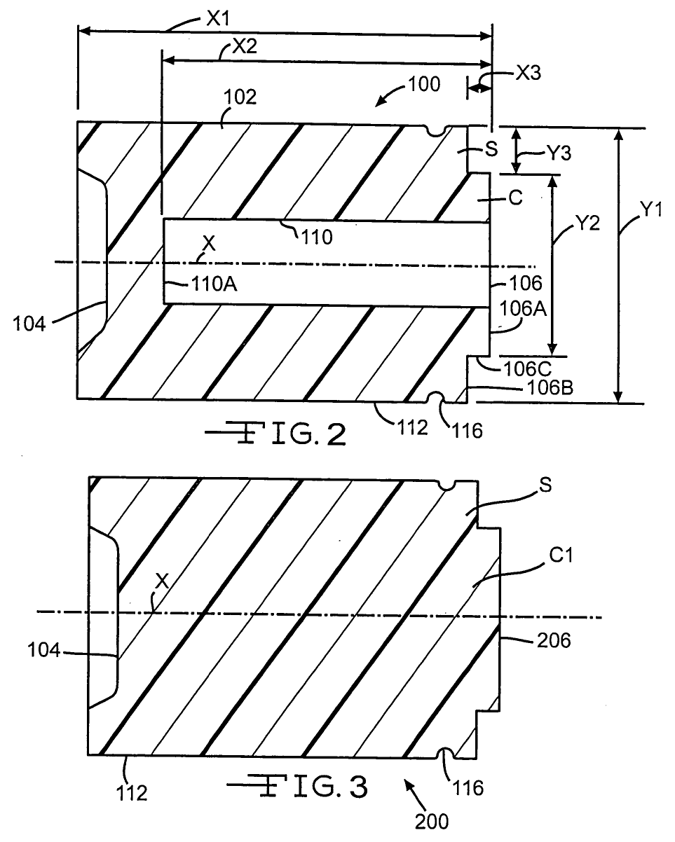

Referring now to FIG. 3 and using like reference numbers to indicated corresponding parts, there is illustrated a second embodiment of a disc brake piston, indicated generally at 200, in accordance with this invention. In this embodiment, the piston 200 includes a solid piston center column C1 as opposed to the partially opened or hollow piston center column C shown in connection with the piston 100 of FIG. 2. Alternatively, the structure of the piston 200 can be other than illustrated if so desired.

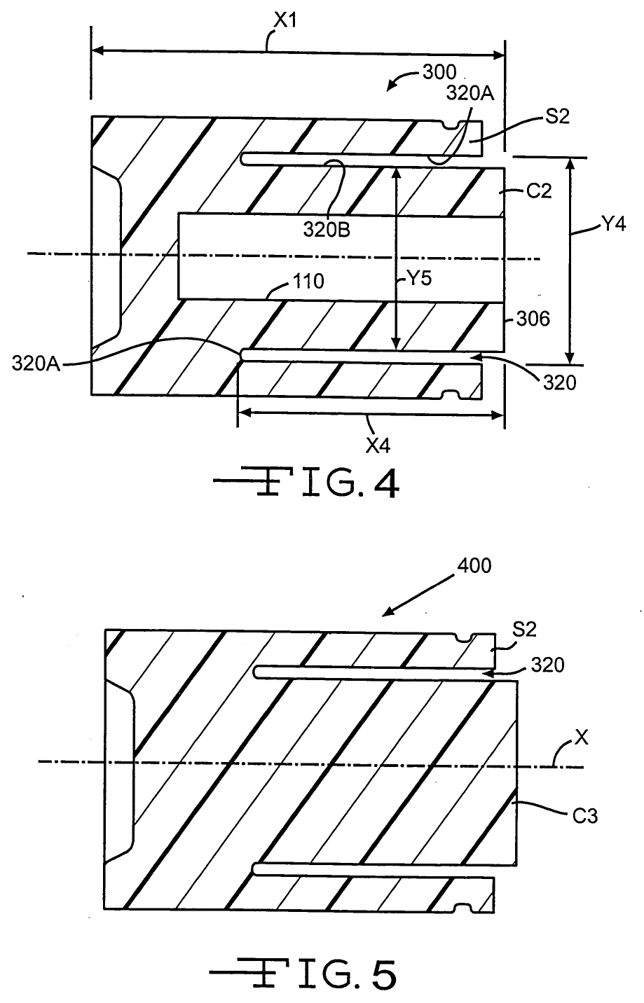

Referring now to FIG. 4 and using like reference numbers to indicate corresponding parts, there is illustrated a third embodiment of a disc brake piston, indicated generally at 300, in accordance with this invention. In this embodiment, the piston 300 includes a cavity or channel 320 formed therein, which is operative to define an air gap in the piston 300. The cavity 320 extends an axial dimension X4 from an opened end 306 to a bottom or end wall 320A of the cavity 320. In the illustrated embodiment, the dimension X4 is greater than one-half the dimension X1; however, the dimension X4 can be generally equal to one-half the dimension X1 or can be less than one-half the dimension X1 if so desired.

The cavity 320 includes an outer cylindrical surface 320A which defines an outer cavity diameter Y4, and an inner cylindrical surface 320B which defines an inner cavity diameter Y5. Preferably, the difference between the outer cavity diameter Y4 and the inner cavity diameter Y5 is in the range from about 0.001 times Y4 to about 0.2 times Y4; however, the difference between the outer cavity diameter Y4 and the inner cavity diameter Y5 can be other than within this range if so desired. The piston 300 defines a piston center column C2 and a piston outer shell S2. Alternatively, the structure of the piston 300 can be other than illustrated if so desired.

Referring now to FIG. 5 and using like reference numbers to indicate corresponding parts, there is illustrated a fourth embodiment of a disc brake piston, indicated generally at 400, in accordance with this invention. In this embodiment, the piston 400 includes a solid piston center column C3 as opposed to the partially opened or hollow piston center column C2 shown in connection with the piston 300 of FIG. 4. Alternatively, the structure of the piston 400 can be other than illustrated if so desired.

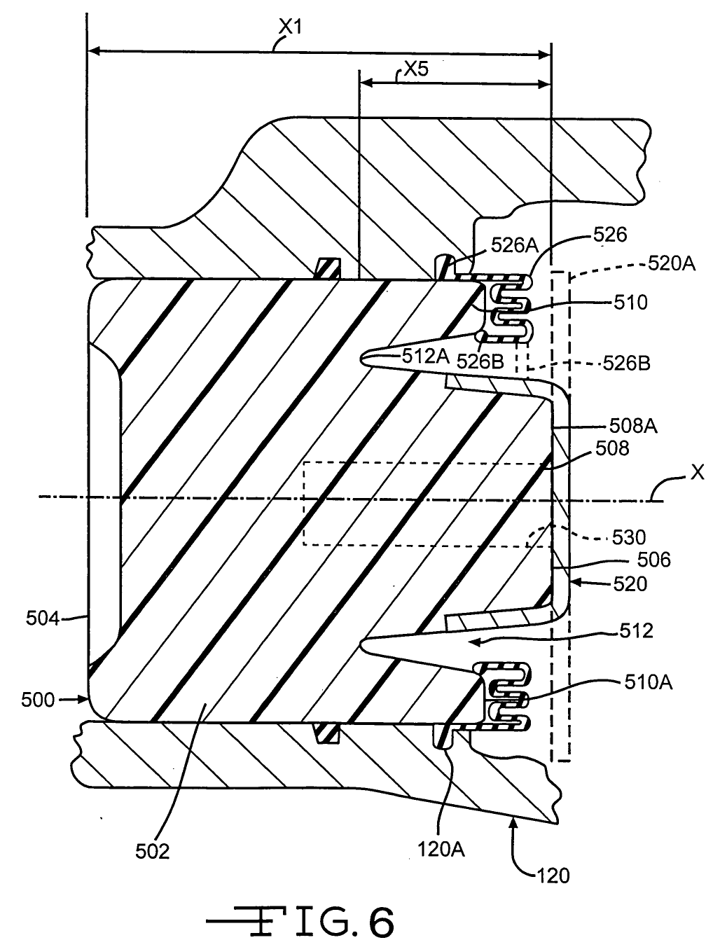

Turning now to FIG. 6 and using like reference numbers to indicate corresponding parts, there is illustrated a fifth embodiment of a disc brake piston, indicated generally at 500, in accordance with this invention, being shown installed in a portion of a caliper 120. As shown therein, the piston 500 includes a body 502 which is preferably molded from a synthetic resin material. However, the piston 500 can be formed from other materials, such as for example, ceramic, titanium and other alloys. The body 502 of the piston 500 is generally cylindrical in shape having a generally closed end 504 and an opposite opened end 506.

The opened end 506 has a stepped configuration and includes a piston center column or post 508 having a first or outermost end 508A, an outer piston shell 510 having a second end 510A which is spaced inwardly relative to the first end 508A toward the closed 504, and a cavity or channel 512 extending inwardly into the piston body 502 and which connects the center post portion 508 to the outer piston shell 510. The cavity 512 can have any suitable shape as desired, such as that shown. Preferably, the shape of the cavity 512 is one that is relatively simple and easy to form during the molding process.

The cavity 512 of the piston 500 extends an axial dimension X5 from the outermost end 508A to a bottom or end wall 512A of the cavity 512. In the illustrated embodiment, the dimension X5 is less than one-half the dimension X1; however, the dimension X5 can be generally equal to one-half the dimension X1 or can be greater than one-half the dimension X1 if so desired.

In this embodiment, a dust boot seal 526 formed from a flexible material has a first end 526A which is disposed in a recess or groove 120A provided in the caliper 120 and a second end 526B which is fitted to an outer surface of the cavity 512 of the piston 500. The second end 526B can be fitted to the piston 500 in any suitable manner, such as for example, by a press-fit or a rubber bead in a groove (not shown) provided in the piston 500. Alternatively, the boot seal 526 can be installed other than illustrated if so desired. For example, the second end 526B (shown in phantom), can be installed onto an optional cap, heat shield, or combination cap and heat shield 520 which is suitably attached to the piston 500. The cap 520 is preferably attached during the molding of the piston 500, and is attached to the piston center column 508. Alternatively, the cap 520 can have outer portions (shown in phantom at 520A), which extend outwardly to protect or shield the boot seal 526. Alternatively, the cap 520 could only include the outer portions 520A. Also, any of the pistons described and illustrated hereinbefore and hereinafter according to the present invention could have a similar heat shield 520 attached thereto if so desired. Alternatively, the structure of the piston 500 can be other than illustrated if so desired. For example, the piston 500 could include a hollow portion, such as shown in phantom at 530 in FIG. 6, within the piston center column 508 if so desired.

Referring now to FIGS. 7, 7A and 7B and using like reference numbers to indicate corresponding parts, there is illustrated a sixth embodiment of a disc brake piston, indicated generally at 600, in accordance with this invention. In this embodiment, the piston 600 includes a cavity 612 which extends generally uniformly in cross-section an axial dimension X11 from a piston end 608A to a bottom or end wall 612A of the cavity 612. In the illustrated embodiment, the dimension X11 is approximately one-half the dimension X1; however, the dimension X11 can be less than or greater than one-half the dimension X1 if so desired. In this embodiment, the bottom wall 612A of the cavity 612 has a unique configuration including an inner radius portion R1, a generally non-radius portion S1, and an outer radius portion R2. The portion S1 is at an angle A1 relative to an inner cylindrical surface 612B of the cavity. Preferably, the angle A1 is in the range from about 15 degrees to about 45 degrees. More preferably, the angle A1 is in the range from about 25 degrees to about 35 degrees. Alternatively, the angle A1 can be other than within this range if so desired.

In the illustrated embodiment, the inner cylindrical surface 612B of the cavity 612 is generally parallel to an outer cylindrical surface 612C of the cavity and the axis X. The inner cylindrical surface 612B defines an inner diameter D1, and the outer cylindrical surface 612C defines an outer diameter D2. In the illustrated embodiment, an end 610A of an outer portion 610 of the piston 600 is spaced axially inwardly relative to an end 608A of a piston center column 608 of the piston 600 a distance X12. Preferably, the difference between the outer diameter D2 and the inner diameter D1 is in the range from about 0.001 times D2 to about 0.2 times D2; however, the difference between the outer diameter D2 and the inner diameter D1 can be other than within this range if so desired. Alternatively, the structure of the piston 600 can be other than illustrated if so desired. For example, the piston 600 could include a hollow portion, such as shown in phantom at 630 in FIG. 7, within the piston center column 608 if so desired.

Referring now to FIG. 8 and using like reference numbers to indicated corresponding parts, there is illustrated a seventh embodiment of a disc brake piston, indicated generally at 700, in accordance with this invention. In this embodiment, the piston 700 includes a solid piston center column 708 having a generally rounded or spherical-shaped end 708A. Alternatively, the structure of the piston 700 can be other than illustrated if so desired. For example, the end of the piston 700 could have a generally rounded or spherical-shaped end 708B as shown in phantom to provide an increased contact area between the piston end and the associated shoe backing plate of the pad assembly compared to that provided by the end 708A.

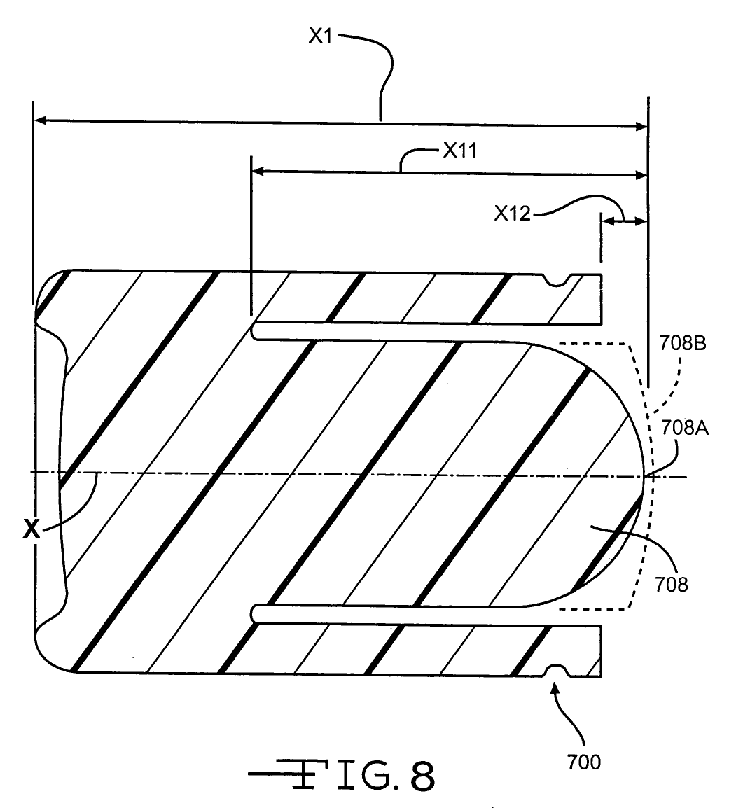

Referring now to FIGS. 9-12 and using like reference numbers to indicated corresponding parts, there is illustrated an eighth embodiment of a disc brake piston, indicated generally at 800 in FIG. 11, in accordance with this invention. In this embodiment, the piston 800 includes a piston body 802 and a cap 804. In this embodiment, the piston body 802 includes a stepped piston center column 808 having a reduced diameter outer portion 808A. The outer reduced diameter portion 808A extends an axial dimension X12 and defines an outer diameter D3.

The cap 804 is preferably made of metal, such as for example, stainless steel, and has a desired thickness, such as for example, about 0.5 mm. Alternatively, the cap 804 can be of any desired thickness and can be formed from other materials, such as for example, aluminum and carbon steel and may be electroplated with zinc for corrosion protection, if so desired. In this embodiment, the cap 804 includes a plurality of optional reinforcing ribs or projections 804A spaced circumferentially around an outer surface 804B of the cap 804. In this embodiment, six generally rectangular-shaped integrally formed ribs 804A which extend less than a height H of the cap 804 are provided thereon. Alternatively, the ribs 804A can be separate pieces attached to the cap 804 by suitable means, such as for example, by welding, brazing, riveting, bonding or any other chemical or mechanical attachment method. Alternatively, the size, shape, number and location of the ribs 804A can be other than illustrated if so desired. Also, in this embodiment, the cap 804 includes an optional vent or through-hole 804C.

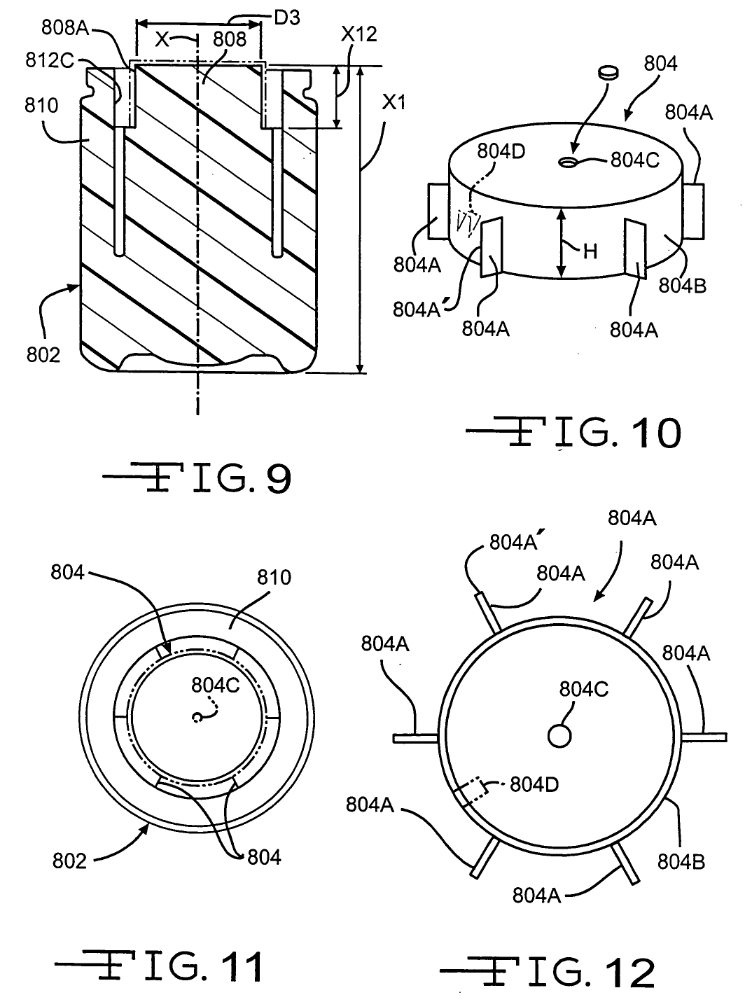

Preferably, the cap 804 is molded into the piston body 802 by being pressed into the piston body 802 prior to the curing cycle. Alternatively, other method can be used to attach the cap 804 to the piston body 802. For example, the cap 804 could include one or more tangs 804D (only one such tang 804D being shown in phantom in FIGS. 10 and 12), which extend inwardly from the cap 804 and which are embedded into the piston body 802 to thereby assist in securing the cap 804 thereto. If the cap 804 includes the ribs 804A, outer edges 804A′ of the ribs 804A are preferably embedded into the material of the outer shell 810 of the piston body 802 to assist in securing the cap 804 to the piston body 802 and also for supporting the outer shell 810 of the piston body 802 during operation of the associated brake assembly. Alternatively, the outer edges 804A′ of the cap 804 can just touch or contact an adjacent inner cylindrical surface 812C of the piston body 802 in such a way to thereby support the outer shell 810 of the piston body 802 during operation of the associated brake assembly. As can be understood, the cap 804 can also include portions (not shown) which extend outwardly therefrom so as to functions as a heat shield similar to that of the outer portions 520A of the cap 520 described above in connection with FIG. 6. Also, any of the pistons described and illustrated hereinbefore and hereinafter according to the present invention could have a similar cap 804 attached thereto if so desired. Alternatively, the structure of one or both of the piston body 802 and the cap 804 can be other than illustrated if so desired.

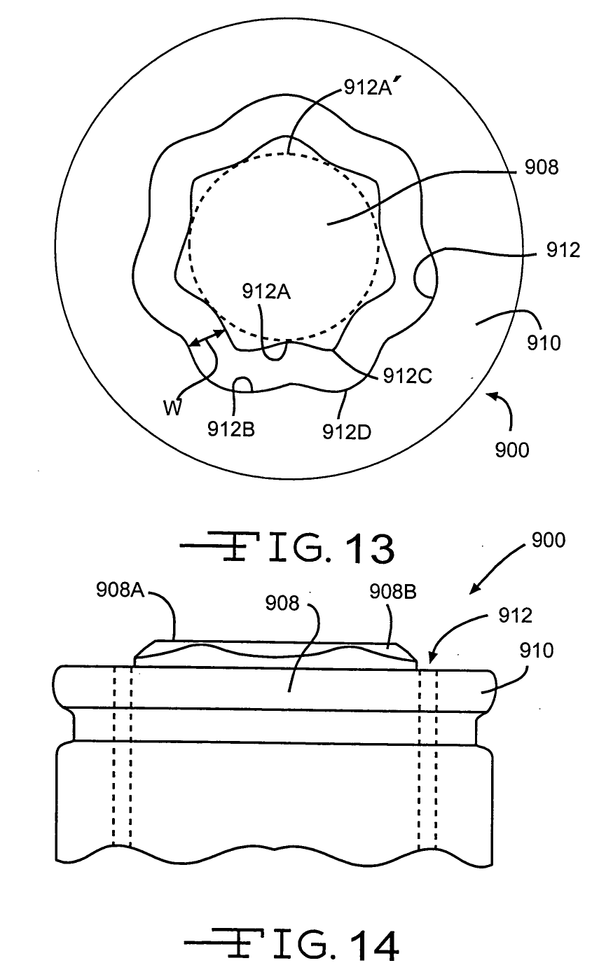

Referring now to FIGS. 13 and 14 and using like reference numbers to indicated corresponding parts, there is illustrated a ninth embodiment of a disc brake piston, indicated generally at 900, in accordance with this invention. In this embodiment, the piston 900 includes a piston center column 908, an outer shell 910, and a cavity 912.

As shown therein, the cavity 912 includes an inner wall 912A and outer wall 912B. In the illustrated embodiment, the inner wall 912A and the outer wall 912B generally resemble one another and have a generally wavy-like or undulating shape of a generally constant radial dimension or width W. This particular shape of the cavity 912 is operative to provide an increased air gap between the piston center column 908 and the outer shell 912 and also creates a plurality of inner ribs 912C and outer ribs 912D. The ribs 912C and 912D are operative to assist in supporting the outer shell 910 of the piston body 900 during operation of the associated brake assembly. Alternatively, the shape of the cavity 912 could be other than illustrated if so desired. For example, the cavity 912 could include other shapes or could be non-uniform, such as an inner wall having a generally cylindrical shape as shown in phantom at 912A′ in FIG. 13.

In this embodiment, the piston center column 908 includes a generally outer end 908A and a side surface 908B. Preferably, the side surface 908B is of a non-uniform or varying surface. In the illustrated embodiment, the side surface 908B is shown as being a chamfered surface. As a result of this, the side surface 908B prevents or reduces loading of the ribs 912C and 912D during brake application. Alternatively, the structure of the piston 900 can be other than illustrated if so desired.

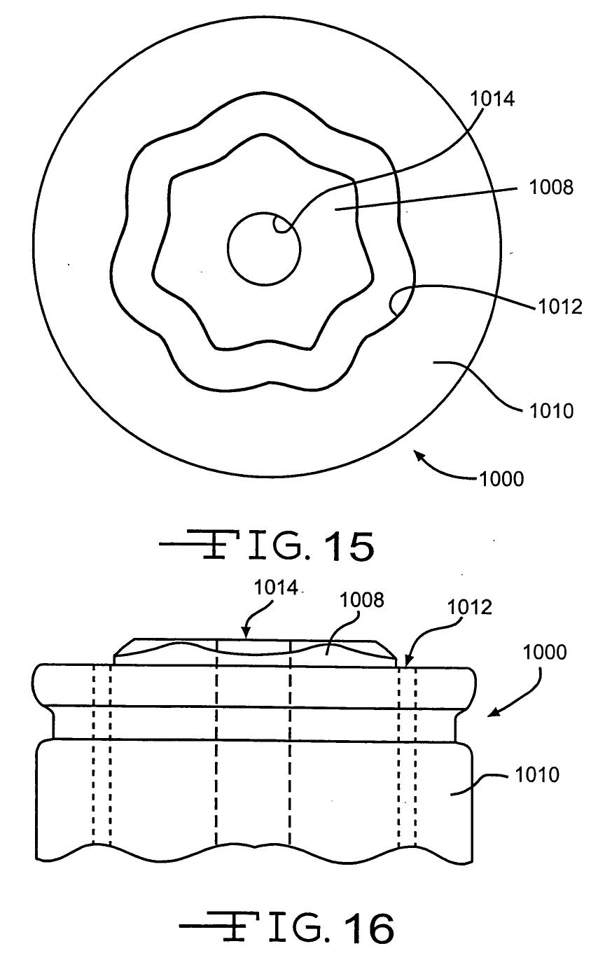

Referring now to FIGS. 15 and 16 and using like reference numbers to indicated corresponding parts, there is illustrated a tenth embodiment of a disc brake piston, indicated generally at 1000, in accordance with this invention. The piston 1000 includes a piston center column 1008, an outer shell 1010, and a cavity 1012. In this embodiment, the piston center column 1008 includes a non-through opening or recess 1014 formed therein. In the illustrated embodiment, the recess 1014 is generally cylindrically shaped. Alternatively, the structure of the piston 1000 can be other than illustrated if so desired.

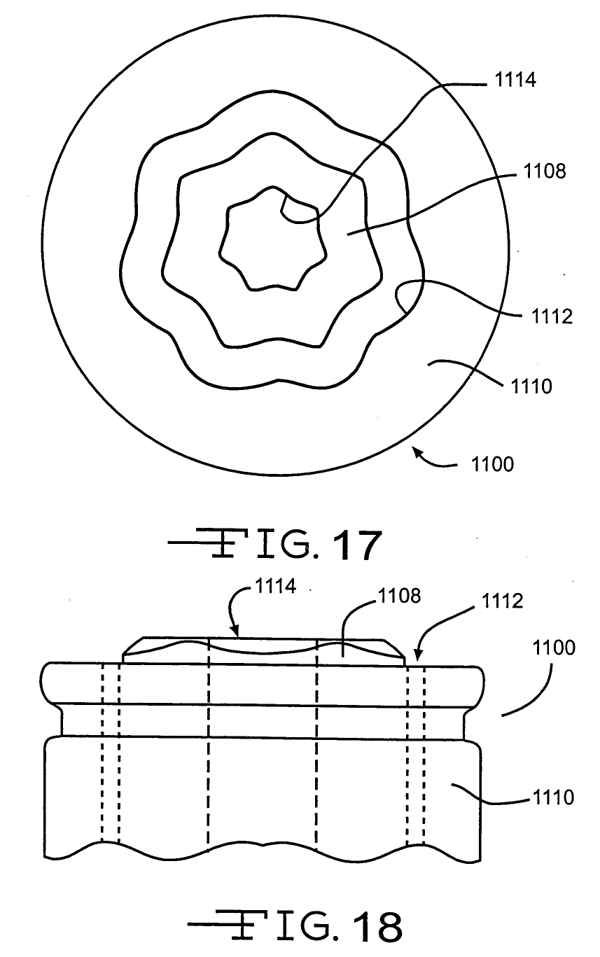

Referring now to FIGS. 17 and 18 and using like reference numbers to indicated corresponding parts, there is illustrated an eleventh embodiment of a disc brake piston, indicated generally at 1100, in accordance with this invention. The piston 1100 includes a piston center column 1108, an outer shell 1110, and a cavity 1112. In this embodiment, the piston center column 1108 includes a non-through opening or recess 1114 formed therein. In the illustrated embodiment, the recess 1114 is generally shaped complimentary to the shape of the cavity 1112. Alternatively, the structure of the piston 1100 can be other than illustrated if so desired.

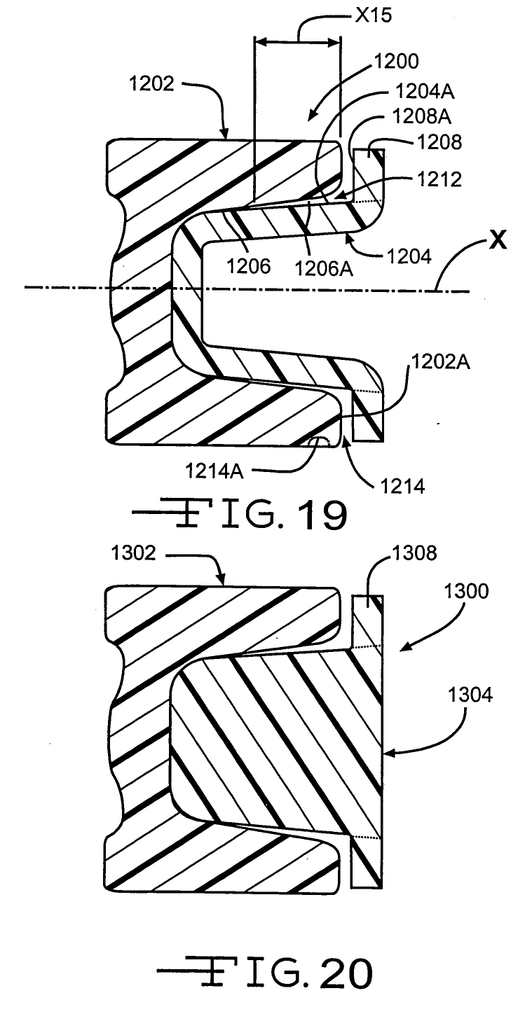

Referring now to FIG. 19 and using like reference numbers to indicated corresponding parts, there is illustrated a twelfth embodiment of a disc brake piston, indicated generally at 1200, in accordance with this invention. The piston 1200 is a multi-piece piston and includes a first piston member 1202 and a second piston member 1204. In the illustrated embodiment, the first piston member 1202 and the second piston member 1204 are formed from the same material, such as for example, molded from a synthetic resin material. However, the first piston member 1202 and/or the second piston member 1204 piston can be formed from other materials, such as for example, ceramic, titanium and other alloys. The first piston member 1202 and the second piston member 1204 are secured together by an appropriate method, such as for example, by a pressing, gluing, pinning, or screwing.

The first piston member 1202 includes a cavity 1206 having an inner side wall 1206A. The second piston member 1204 is generally double Z-shaped and includes an outer side wall 1204A and an outer flange 1208 having an inner wall 1208A. The outer side wall 1204A and inner side wall 1206A are configured so as to define a cavity 1212 between at least a portion thereof in an axially extending direction. In the illustrated embodiment, the cavity 1212 is non-uniform and extends an axial distance X15. Alternatively, the shape and/or the size of the cavity 1212 can be other than illustrated if so desired.

In this embodiment, the inner wall 1208A is spaced apart from an end wall 1202A of the first piston member 1202 to define a seat, indicated generally at 1214, for receiving an associated end of a dust boot groove seal. Alternatively, the first piston member 1202 or the second piston member 1204 could be provided with a groove (such as shown in phantom at 1214A in FIG. 19), for receiving an associated end of the dust boot groove seal. Alternatively, the structure of the piston 1200 can be other than illustrated if so desired. For example, the second piston member 1204 could be generally U-shaped and not include the outer flange 1208, as shown in phantom.

Referring now to FIG. 20 and using like reference numbers to indicated corresponding parts, there is illustrated a thirteenth embodiment of a disc brake piston, indicated generally at 1300, in accordance with this invention. The piston 1300 is a multi-piece piston and includes a first piston member 1302 and a second piston member 1304. In the illustrated embodiment, the second piston member 1304 is a generally hat-shaped solid member with an outer flange 1308. Alternatively, the structure of the piston 1300 can be other than illustrated if so desired.

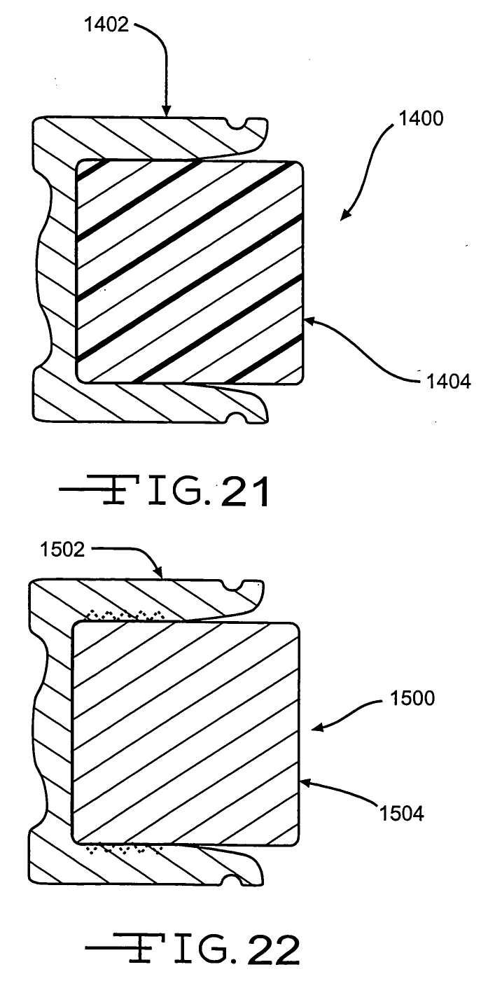

Referring now to FIG. 21 and using like reference numbers to indicated corresponding parts, there is illustrated a fourteenth embodiment of a disc brake piston, indicated generally at 1400, in accordance with this invention. The piston 1400 is a multi-piece piston and includes a first piston member 1402, formed from a metal, and a second piston member 1404, formed from a non-metal material, such as a synthetic resin material. The first piston member 1402 and the second piston member 1404 are joined together by a suitable method, such as for example, by pressing, gluing, pinning, screwing, bonding or any other chemical and/or mechanical attachment method. Alternatively, the structure of the piston 1400 can be other than illustrated if so desired.

Referring now to FIG. 22 and using like reference numbers to indicated corresponding parts, there is illustrated a fifteenth embodiment of a disc brake piston, indicated generally at 1500, in accordance with this invention. The piston 1500 is a multi-piece piston and includes a first piston member 1502, formed from a metal, and a second piston member 1504, formed from a metal. The first piston member 1502 and the second piston member 1504 are joined together by a suitable method, such as for example, by pressing, gluing, pinning, screwing, or any other chemical and/or mechanical attachment method. Alternatively, the structure of the piston 1500 can be other than illustrated if so desired.

It is believed that one potential advantage of one or more of the brake piston designs of the present invention is that it is effective to reduce the heat transfer into the brake fluid that surrounds the brake piston. The designs of one or more of the brake pistons of the present invention may possibly achieve that reduction as follows: 1. Reduced Cross-Sectional Area—The main conductive heat path from the back of the inboard shoe plate to the fluid that surrounds the piston is now through the piston center column, not through the outer shell. The cross-sectional area of such a column can be made less than that of the piston outer shell, particularly if the column has a hollow core. Reduced cross-sectional area results in greater resistance to conductive heat leak into the brake fluid; 2. Increased Length of Conductive Path—In conventional pistons, there is a short and very direct conductive heat path from the back of the shoe plate into the brake fluid, directly behind the seal. In the designs of the brake pistons of the present invention, this direct path does not exist, because the end of the piston outer shell does not contact the shoe plate. Instead, heat from the shoe plate enters the end of the center column. From there, it travels roughly halfway down the column before it is conducted radially outward through the piston outer shell into the brake fluid. This increased length of path results in greater resistance to conductive heat leak into the brake fluid; 3. Reduced Radiation—In conventional pistons, there is a direct radiation path from the back of the shoe plate into the entire interior surface of the outer shell. In the brake piston designs of the present invention, the view factor for this radiative heat leak is reduced substantially by the presence of the center column; 4. Increased Thermal Mass—In the brake piston designs of the present invention, the center column essentially represents thermal mass that is over and above what is found in conventional pistons. Increasing thermal mass delays the passage of the heat pulse into the brake fluid, and reduces the pulse magnitude; and 5. Thermal Protection for Dust Boot—In severe service, conventional pistons are subjected to possible occurrence of boot burning. The key problem is that portions of the boot are typically located very near the back of the inboard shoe plate. Also, they have a direct “view” of radiation that emanates from that plate and from the rotor. The designs of the brake pistons of the present invention may enable the designer to alleviate these conditions. Because the outer shell ends short of the shoe plate, the boot can be reconfigured to space it farther from the shoe plate than is usual. Furthermore, an optional heat or radiation shield can be attached to the cap that protects the center column, or to the column itself, if no cap is used.

In addition to the fluid boil issues discussed above, there may be other potential advantages of one or more of the brake piston designs of the present invention: 1. Reduced Fluid Displacement—At high pressures, conventional pistons require significant amounts of fluid displacement to overcome piston deflections. This is particularly true when a piston is made of a compliant material, such as a glass-filled phenolic. The brake piston designs of the present invention may provide reduced fluid displacement, as compared to conventional pistons. This improvement is due to the fact that the overall stiffness of the piston is greater. Additional benefit accrues as the friction material wears. As the brake piston repositions itself to compensate for wear, the outboard end of the piston (which is its most compliant region) gradually ceases to be subjected to fluid pressure. The part that continues to be subjected to fluid pressure is essentially a solid block of material, which is the stiffest possible structure that can be accommodated within the available design envelope. This gradual stiffening tends to counteract fluid displacement increases that result from taper wear and/or other wear-related phenomena; 2. Enhancements to Protective Cap—In conventional phenolic pistons, it is customary to supply a protective metal cap that is molded over the open end of the piston. The height of this cap in the axial direction is limited by considerations of boot groove and seal clearance. The brake piston designs of the present invention suffer from no such limitations. Because the protective cap can be attached to the center column, rather than to the piston outer shell, those clearance considerations do not apply. In fact, the cap can extend the full height of the center column if desired. A taller cap would provide greater thermal protection, and would also stiffen and reinforce the center column. The net effect would be an increase in burst strength and a reduction in fluid displacement due to piston deflection. Furthermore, such a column-mounted protective cap is an ideal place to mount an optional radiation heat shield for the piston/boot assembly; 3. Structural Advantages—In a conventional piston, the outer shell must withstand pressure loads from brake fluid, and axial loads as the piston presses against the shoe plate. In many designs, the piston overhangs the shoe plate. Any such radial overhang produces stress concentrations that can lead to shear failure in a caliper burst test. Additional stress concentrations are found at the boot groove, which is also subjected to high, non-uniform loadings. In the brake piston designs of the present invention, the outer shell reacts the pressure load. The center column takes the axial load. Piston overhang can readily be avoided because the center column necessarily has a much smaller outer diameter than does the outer shell. Stress concentrations in the boot groove are of small consequence, because, in the absence of axial loading, that region of the outer shell is not highly stressed.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

1. A piston adapted for use in a disc brake assembly comprising:
a piston including a first end and an opposite second end, wherein at least one of said first and second ends includes a center column and an outer shell, said center column protruding outwardly beyond said outer shell.

2. The piston according to claim 1 wherein said center column includes a cavity formed therein.

3. The piston according to claim 1 wherein a cavity is formed in said piston to transition from an outer portion of said center column to an inner portion of said outer shell.

4. The piston according to claim 3 wherein said cavity has a shape which is operative to provide at least one increasing an air gap between said center column and said outer shell and supporting said outer shell during operation of the brake assembly.

5. The piston according to claim 3 wherein said cavity extends at least one-half a length defined by said piston.

6. The piston according to claim 3 wherein said cavity is an annular cavity and includes an outer cylindrical surface which defines an outer cavity diameter and an inner cylindrical surface which defines an inner cavity diameter.

7. The piston according to claim 6 wherein the difference between said outer cavity diameter and said inner cavity diameter is in the range from about 0.001 times said outer cavity diameter to about 0.2 times said outer cavity diameter.

8. The piston according to claim 1 wherein said piston is a molded one-piece piston.

9. The piston according to claim 1 wherein said piston is a multi-piece piston and includes a first piston member and a second piston member operatively joined together.

10. The piston according to claim 1 wherein said piston includes a cap attached to said center column.

11. The piston according to claim 1 wherein said piston includes a cap and a heat shield attached to said center column.

12. The piston according to claim 1 wherein said piston includes a heat shield attached to said center column.

13. A piston adapted for use in a disc brake assembly comprising:
a piston including a body having a generally cylindrical shape and having a generally closed first end and an opposite second end, said second end having a stepped configuration including a center column having a first remote end surface and an outer shell having a second remote end surface which is spaced inwardly relative to said first remote end surface.

14. The piston according to claim 13 wherein said center column includes a cavity formed therein.

15. The piston according to claim 13 wherein a cavity is formed in said piston to transition from an outer portion of said center column to an inner portion of said outer shell.

16. The piston according to claim 15 wherein said cavity has a shape which is operative to provide at least one of an air gap between said center column and said outer shell and a structure for supporting said outer shell during operation of the brake assembly.

17. The piston according to claim 15 wherein said cavity extends at least one-half a length defined by said piston.

18. The piston according to claim 15 wherein said cavity is an annular cavity and includes an outer cylindrical surface which defines an outer cavity diameter and an inner cylindrical surface which defines an inner cavity diameter.

19. The piston according to claim 18 wherein the difference between said outer cavity diameter and said inner cavity diameter is in the range from about 0.001 times said outer cavity diameter to about 0.2 times said outer cavity diameter.

20. The piston according to claim 13 wherein said piston is a molded one-piece piston.

21. The piston according to claim 13 wherein said piston is a multi-piece piston and includes a first piston member and a second piston member operatively joined together.

22. The piston according to claim 13 wherein said piston includes a cap attached to said center column.

23. The piston according to claim 13 wherein said piston includes a cap and a heat shield attached to said center column.

24. The piston according to claim 13 wherein said piston includes a heat shield attached to said center column.

25. A disc brake assembly comprising:
a caliper including at least one recess formed therein;
a piston slidably disposed in said at least one recess;
a pair of friction pads carried by said caliper and disposed on opposite axial sides of an associated rotor; and
actuation means carried by said caliper for selectively moving said friction pads between a non-braking position, wherein each of said friction pads is spaced apart from the adjacent side of the rotor, and a braking position, wherein said each of said friction pads frictionally engages the adjacent side of the rotor;
wherein said piston includes a first end and an opposite second end, at least one of said first and second ends includes a center column and an outer shell, said center column protruding outwardly beyond said outer shell, and wherein a cavity is formed in said piston to transition from an outer portion of said center column to an inner portion of said outer shell.
